(19) United States
(12) Patent Application Publication
(10) Pub. No.: US 2006/0093942 A1
(43) Pub. Date: May 4, 2006

(54) Process for preparing toner

(75) Inventor: Akihiro Eida, Wakayama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kao Corporation, Chuo-ku (JP)

(21) Appl. No.: 11/249,330

(22) Filed: Oct. 14, 2005

(30) Foreign Application Priority Data
Oct. 29, 2004 (JP) 2004-315999

(51) Int. Cl. G03G 9/08

(52) U.S. Cl. 430/108.7; 430/137.22

(57) ABSTRACT

A process for preparing a toner including the steps of (I) melt-kneading a raw material mixture containing a resin binder, a colorant, and a positively chargeable charge control agent; (II) cooling the melt-kneaded mixture obtained in the step (I), and pulverizing the cooled mixture in the presence of a positively chargeable silica; and (III) classifying the pulverized product obtained in the step (II), wherein the positively chargeable silica in the step (II) is present in an amount of from 0.8 to 6 parts by weight, based on 100 parts by weight of the melt-kneaded mixture obtained in the step (I). The toner obtained according to the present invention can be used for, for example, developing a latent image formed in electrophotography, electrostatic recording method, electrostatic printing method, or the like.

### FIELD OF THE INVENTION

The present invention relates to a process for preparing a toner used for, for example, developing a latent image formed in electrophotography, electrostatic recording method, electrostatic printing method, or the like.

### BACKGROUND OF THE INVENTION

In preparation of a toner, a process for adding a fluidity improver such as silica during pulverization has conventionally been proposed. For example, JP-A-Hei-10-186721 discloses a process for preparing a toner having a sharp particle size distribution, including the step of finely pulverizing a roughly pulverized product while adding a fluidity improver having a higher specific gravity than the roughly pulverized product.

### SUMMARY OF THE INVENTION

The present invention relates to a process for preparing a toner including the steps of:

(I) melt-kneading a raw material mixture containing a resin binder, a colorant, and a positively chargeable charge control agent;

(II) cooling the melt-kneaded mixture obtained in the step (I), and pulverizing the cooled mixture in the presence of a positively chargeable silica; and

(III) classifying the pulverized product obtained in the step (II),

wherein the positively chargeable silica in the step (II) is present in an amount of from 0.8 to 6 parts by weight, based on 100 parts by weight of the melt-kneaded mixture obtained in the step (I).

### DETAILED DESCRIPTION OF THE INVENTION

The present invention relates to a process capable of preparing a toner having a small particle size and a sharp particle size distribution with excellent productivity.

According to the present invention, a toner having a small particle size and a sharp particle size distribution can be prepared with excellent productivity.

These and other advantages of the present invention will be apparent from the following description.

In preparation of a toner, a process of adding an external additive during pulverization of a melt-kneaded mixture has been known. In a case where a toner is prepared by pulverizing a melt-kneaded mixture containing a positively chargeable charge control agent, pulverization with adding only a negatively chargeable silica causes the silica to electrostatically aggregate on the toner surface. Therefore, it is preferable that a positively chargeable silica is further added to the above added mixture and pulverize the mixture. However, a positively chargeable silica is likely to be less effective in giving fluidity than a negatively chargeable silica, so that the effects may not be exhibited during the pulverization depending on the amount in some cases. This tendency is particularly remarkable in preparation of a toner having a small particle size.

In view of the above, as a result of further studies, the present inventors have found that in a case where a toner is prepared by pulverizing a melt-kneaded mixture containing a positively chargeable charge control agent, a toner having a sharp particle size distribution even with a small particle size can be obtained by pulverizing the melt-kneaded mixture in the presence of a specified amount of a positively chargeable silica. Although not wanting to be limited by theory, the reason why the above toner is obtained is as follows. By pulverizing the melt-kneaded mixture under the above conditions, the silica is homogeneously dispersed on the toner surface during the pulverization, so that the melt-kneaded mixture is homogeneously pulverized without being aggregated.

The process for preparing a toner of the present invention includes at least the steps of:

(I) melt-kneading a raw material mixture containing a resin binder, a colorant, and a positively chargeable charge control agent;

(II) cooling the melt-kneaded mixture obtained in the step (I), and pulverizing the cooled mixture in the presence of a positively chargeable silica; and

(III) classifying the pulverized product obtained in the step (II).

The step (I) is a step of melt-kneading a raw material mixture containing a resin binder, a colorant, and a positively chargeable charge control agent.

The resin binder includes polyesters, styrene-acrylic resins, a mixed resin of a polyester and a styrene-acrylic resin, a hybrid resin containing two or more resin components, and the like. The resin binder containing a polyester as a main component is preferable, from the viewpoint of dispersibility of the colorant and transparency. The polyester is contained in the resin binder in an amount of preferably from 50 to 100% by weight, and more preferably from 70 to 100% by weight. As the hybrid resin, a resin in which a polycondensation resin, such as a polyester, a polyester-polyamide, or a polyamide, and an addition polymerization resin such as a vinyl polymer-based resin are partially chemically bonded to each other is preferable. The hybrid resin may be obtained by using two or more resins as raw materials, or the hybrid resin may be obtained by using a mixture of one kind of resin and raw material monomers for the other resin. In order to efficiently obtain a hybrid resin, those obtained from a mixture of raw material monomers of two or more resins are preferable.

The raw material monomer for the polyester is not particularly limited, as long as a known alcohol component and a known carboxylic acid component such as carboxylic acids, acid anhydrides thereof and esters thereof are used.

The alcohol component includes an alkylene (2 or 3 carbon atoms) oxide (average number of moles: 1 to 16) adduct of bisphenol A, such as polyoxypropylene(2.2)-2,2-bis(4-hydroxyphenyl)propane and polyoxyethylene(2.2)-2,2-bis(4-hydroxyphenyl)propane; ethylene glycol, propylene glycol, glycerol, pentaerythritol, trimethylolpropane, hydrogenated bisphenol A, sorbitol, or an alkylene (2 to 4 carbon atoms) oxide (average number of moles: 1 to 16) adduct thereof; and the like.

In addition, the carboxylic acid component includes dicarboxylic acids such as phthalic acid, isophthalic acid, terephthalic acid, fumaric acid, maleic acid, adipic acid, and succinic acid; a substituted succinic acid of which substituent is an alkyl group having 1 to 20 carbon atoms or an alkenyl group having 2 to 20 carbon atoms, such as dodecenylsuccinic acid or octenylsuccinic acid; tricarboxylic or higher polycarboxylic acids such as 1,2,4-benzenetricarboxylic acid (trimellitic acid) and pyromellitic acid; acid anhydrides thereof; alkyl (1 to 3 carbon atoms) esters thereof; and the like.

The polyester can be prepared by, for example, polycondensation of the alcohol component and the carboxylic acid component at a temperature of from 180° to 250° C. in an inert gas atmosphere in the presence of an esterification catalyst as desired.

The polyester has a softening point of preferably from 80° to 165° C., a glass transition temperature of preferably from 50° to 85° C., and an acid value of preferably from 5 to 40 mg KOH/g.

As the colorants, all of the dyes, pigments, and the like which are used as colorants for toners can be used. The colorant includes carbon blacks, Phthalocyanine Blue, Permanent Brown FG, Brilliant Fast Scarlet, Pigment Green B, Rhodamine-B Base, Solvent Red 49, Solvent Red 146, Solvent Blue 35, quinacridone, carmine 6B, disazoyellow, and the like. These colorants can be used alone or in admixture of two or more kinds. The toner prepared according to the present invention may be any of black toners and color toners. The amount of the colorant contained is preferably from 1 to 40 parts by weight, and more preferably from 3 to 10 parts by weight, based on 100 parts by weight of the resin binder.

As the positively chargeable charge control agent, Nigrosine dyes, for example, “Nigrosine Base EX,” “Oil Black BS,” “Oil Black SO,” “BONTRON N-01,” “BONTRON N-07,” “BONTRON N-09,” and “BONTRON N-11” (hereinabove commercially available from Orient Chemical Co., Ltd.), and the like; triphenylmethane-based dyes containing a tertiary amine as a side chain, quaternary ammonium salt compounds, for example, “BONTRON P-51” and “BONTRON P-52” (hereinabove commercially available from Orient Chemical Co., Ltd.), “TP-415” (commercially available from HODOGAYA CHEMICAL CO., LTD.), cetyltrimethylammonium bromide, “COPY CHARGE PX VP435” (commercially available from Hoechst AG), and the like; polyamine resins, for example, “AFP-B” (commercially available from Orient Chemical Co., Ltd.) and the like; and imidazole derivatives, for example, “PLZ-2001” and “PLZ-8001” (hereinabove commercially available from Shikoku Chemicals Corporation), and the like. Among them, quaternary ammonium salt compounds are preferable from the viewpoint of initial rise of triboelectric charges.

The positively chargeable charge control agent is contained in the raw material mixture used in the step (I) in an amount of preferably from 0.2 to 5% by weight, more preferably from 0.3 to 4% by weight, and even more preferably from 0.3 to 3% by weight.

Further, a negatively chargeable charge control agent may be used together with the positively chargeable charge control agent as long as the effects of the present invention are not impaired.

In the present invention, additives such as fluidity improvers, electric conductivity modifiers, extenders, reinforcing fillers such as fibrous substances, antioxidants, anti-aging agents, cleanability improvers, and magnetic materials may be further contained as raw materials in the toner.

It is preferable that a raw material such as a resin binder, a colorant, and a positively chargeable charge control agent is pre-mixed with a Henschel mixer or the like and subjected to melt-kneading.

In the present invention, it is preferable that a raw material such as a resin binder, a colorant, a positively chargeable charge control agent, and an additive such as a releasing agent is pre-mixed with a Henschel mixer or the like and subjected to the step of melt-kneading. The raw material mixture can be melt-kneaded according to the conventional method with a known kneader such as a closed type kneader, a single-screw or twin-screw extruder, or an open-roller type kneader.

For example, an open-roller type kneader refers to a kneader containing at least two rollers, and a melt-kneading member is an open type, and it is preferable that at least two of the rollers are a heat roller and a cooling roller. The open-roller type kneader can easily dissipate the kneading heat generated during the melt-kneading. In addition, it is preferable that the open-roller type kneader is a continuous type kneader, from the viewpoint of production efficiency.

Further, in the above-mentioned open-roller type kneader, two of the rollers are arranged in parallel closely to each other, and the gap between the rollers are preferably from 0.01 to 5 mm, and more preferably from 0.05 to 2 mm. In addition, structures, sizes, materials, and the like of the roller are not particularly limited. Also, the roller surface may be any of smooth, wavy, rugged or other surfaces.

The number of rotation of the roller, i.e. the peripheral speed of the roller, is preferably from 2 to 100 m/min. The peripheral speed of the cooling roller is preferably from 2 to 100 m/min, more preferably from 10 to 60 m/min, and even more preferably 15 to 50 m/min. In addition, it is preferable that the two rollers have different peripheral speeds from each other, and that the ratio of the peripheral speed of the two rollers (cooling roller/heat roller) is preferably from 1/10 to 9/10, and more preferably from 3/10 to 8/10.

In order to facilitate adhesion of the kneaded product to the heat roller, it is preferable that the temperature of the heat roller is adjusted to be higher than both the softening point of the resin binder and the melting point of the wax, and that the temperature of the cooling roller is adjusted to be lower than both the softening point of the resin binder and the melting point of the wax. Specifically, the temperature of the heat roller is preferably from 80° to 200° C., and the temperature of the cooling roller is preferably from 20° to 140° C.

The difference in temperature between the heat roller and the cooling roller is preferably from 60° to 150° C., and more preferably from 80° to 120° C.

Here, the temperature of the roller can be adjusted by, for example, a heating medium passing through the inner portion of the roller, and each roller may be divided in two or more portions in the inner portion of the roller, each being communicated with heating media of different temperatures.

It is preferable that the temperature of the heat roller, especially the raw material feeding side of the heat roller, is adjusted to be higher than both the softening point of the resin binder and the melting point of each wax, more preferably a temperature calculated from the temperature higher than the higher of the softening point of the resin binder and the melting point of each wax plus 0° to 80° C., and even more preferably a temperature calculated from the temperature plus 5° to 50° C. It is preferable that the temperature of the cooling roller is adjusted to be lower than both of the softening point of the resin binder and the melting point of each wax, more preferably a temperature calculated from the temperature lower than the lower of the softening point of the resin binder and the melting point of each wax minus 0° to 80° C., and even more preferably a temperature calculated from the temperature minus 400 to 80° C.

The step (II) is a step of cooling the melt-kneaded mixture obtained in the step (I), and pulverizing the cooled mixture in the presence of a positively chargeable silica. One of the features of the step (II) resides in the amount of the positively chargeable silica.

The positively chargeable silica in the step (II) is present in an amount of from 0.8 to 6 parts by weight, preferably from 1 to 5 parts by weight, and more preferably from 1.5 to 4 parts by weight, based on 100 parts by weight of the melt-kneaded mixture obtained in the step (I), from the viewpoint of having an appropriate effect in giving fluidity.

As the positively chargeable silica, a silica treated with a hydrophobic treatment agent which gives positive chargeability is preferable.

Fine powders of silica (SiO₂) may be prepared by any of dry method or wet method. In addition, besides anhydrous silica, the fine powders of silica may be aluminum silicate, sodium silicate, potassium silicate, magnesium silicate or zinc silicate, of which SiO₂ content is 85% by weight or more is preferable.

The hydrophobic treatment agent for giving positive chargeability to the silica is not particularly limited. The hydrophobic treatment agent includes aminosilanes; silicone oil treatment agents such as amino-modified silicone oils and epoxy-modified silicone oils; and the like. Among them, the amino-modified silicone oils are preferable from the viewpoint of environmental stability of triboelectric charges.

The treated amount of the hydrophobic treatment agent is not particularly limited, as long as the treated amount is in an extent that the desired positive triboelectric charges and degree of hydrophobicity are obtained. It is preferable that the treated amount per surface area of the silica is preferably from 1 to 7 mg/m².

Commercially available positively chargeable silicas which can be preferably used in the present invention include, for example, preferred commercially available products of amino-modified silicone oil such as “HVK2150,” “HDK3050,” “HDK H30TA,” “HDK H20TA,” “HDK H13TA,” and “HDK H05TA” (hereinabove commercially available from Wacker Chemicals), “NA50H,” “AEROSIL RA200H,” and “AEROSIL RA200HS” (hereinabove commercially available from Degussa), and the like.

The positively chargeable silica has an average particle size of preferably from 4 to 40 nm, and more preferably from 8 to 20 nm, from the viewpoint of giving fluidity. Here, the average particle size refers to a number-average particle size.

The temperature to which the melt-kneaded mixture obtained in the step (I) is cooled is not particularly limited, as long as the melt-kneaded mixture is properly cooled to a pulverizable hardness.

The melt-kneaded mixture cooled in the step (II) may be pulverized once or in divided plural times. It is preferable that the pulverization includes rough pulverization and fine pulverization, from the viewpoint of pulverization efficiency and production efficiency. It is preferable that the melt-kneaded mixture is previously roughly pulverized to give a volume-median particle size (D₅₀v) of from 10 to 1000 μm or so, and thereafter the resulting roughly pulverized product is further finely pulverized in consideration of the particle size of the desired toner.

When the pulverization step is carried out separately as a rough pulverization step and a fine pulverization step, the positively chargeable silica may be present in either of the pulverization steps. It is, however, preferable that the fine pulverization step is carried out in the presence of the positively chargeable silica, from the viewpoint of dispersibility of the positively chargeable silica on the toner surface.

The step of roughly pulverizing the cooled mixture can be carried out with Atomizer, Rotoplex, or the like.

The pulverizer usable in the step of finely pulverizing the roughly pulverized product includes a jet type pulverizer such as a fluidized bed type jet mill and a gas stream type jet mill; a mechanical pulverizer such as a turbo mill; and the like. From the viewpoint of further remarkably exhibiting the effect of dispersing the wax in the specified particle size of the present invention, the jet type pulverizer is preferable.

The fluidized bed type jet mill usable in the present invention includes, for example, a pulverizer having the structure and principle for finely pulverizing the particles, containing at least a pulverization chamber arranged facing two or more jet nozzles in its lower portion thereof, in which a fluidized bed is formed with the particles fed into the pulverizing container by a high-speed gas jet stream discharged from the jet nozzles wherein the particles are finely pulverized by repeating the acceleration of the particles and impact between the particles.

In the jet mill having the above-mentioned structure, the number of jet nozzles is not particularly limited. It is preferable that two or more jet nozzles, and preferably from 3 to 4 jet nozzles are arranged facing each other, from the viewpoint of balance between volume of air, amount of flow and flow rate, impact efficiency of the particles, and the like.

Further, a classifying rotor for capturing uplifted particles having small particle sizes downsized by pulverization is provided in an upper part of the pulverization chamber. The particle size distribution can be easily adjusted by a rotational speed of the classifying rotor. The finely pulverized product (upper limit cut-off classification powder) can be obtained by classifying the pulverized product with the classifying rotor.

The classifying rotor may be arranged in any of longitudinal direction and latitudinal direction against the vertical direction. It is preferable that the classifying rotor is arranged in the longitudinal direction, from the viewpoint of classifying performance.

Specific examples of a fluidized bed type jet mill containing two or more jet nozzles and further containing a classifying rotor include pulverizers disclosed in JP-A-Showa-60-166547 and JP2002-35631 A.

The fluidized-bed jet mill which may be preferably used in the present invention includes the “TFG” Series commercially available from Hosokawa Micron Corporation, the “AFG” Series commercially available from Hosokawa Micron Corporation, and the like.

In addition, the gas stream type jet mill includes, for example, an impact type jet mill containing a venturi nozzle and an impact member arranged so as to face the venturi nozzle, and the like.

The gas stream type jet mill which may be preferably used in the present invention includes the “IDS” Series commercially available from Nippon Pneumatic Mfg. Co., Ltd., and the like.

A process for pulverizing the pulverized products in the presence of the positively chargeable silica includes a process including the step of previously mixing a melt-kneaded mixture or a roughly pulverized product and a positively chargeable silica before pulverization; a process including the step of mixing a melt-kneaded mixture or a roughly pulverized product and a positively chargeable silica, and at the same time feeding the mixture to a pulverizer; a process including the step of feeding a melt-kneaded mixture or a roughly pulverized product and a positively chargeable silica each from a separate feeding port to a pulverizer; and the like, without being particularly limited thereto. In the present invention, the process including the step of previously mixing the roughly pulverized product and the positively chargeable silica is preferable, from the viewpoint of adhesion of the positively chargeable silica.

When the roughly pulverized product and the positively chargeable silica are fed into the pulverizer, the pulverization proceeds by an impact between the roughly pulverized products while another impact occurs between the (roughly) pulverized product and the positively chargeable silica, so that the positively chargeable silica is adhered to the surface of the pulverized product. When the positively chargeable silica is present in an amount corresponding to the desired toner, the positively chargeable silica can be adhered to the surface of the mother toner particles with an appropriate amount and adhesive strength.

The roughly pulverized product and the positively chargeable silica can be mixed, for example, with a mixer capable of agitating at a high speed, such as a Henschel mixer or a Super mixer.

Next, the pulverized product obtained according to the step (II) is subjected to the step (III).

The step (III) is a step of classifying the pulverized product obtained in the step (II).

The classifier usable in the step (III) includes air classifiers, rotor type classifiers, sieve classifiers, and the like. In the present invention, it is preferable that the classifier contains a classifying rotor containing a driving shaft arranged in a casing as a central shaft thereof in a vertical direction, and a stationary spiral guiding vane arranged to share the same central shaft as the classifying rotor, wherein the stationary spiral guiding vane in a classification zone on an outer circumference of the classifying rotor with a given spacing to the outer circumference of the classifying rotor, from the viewpoint of ability of removing fine powders. Specific examples of the classifier having the structure described above include a classifier shown in FIG. 2 of JP-A-Hei-11-216425, a classifier shown in FIG. 6 of JP2004-78063 A, commercially available classifiers such as the “TSP” Series commercially available from Hosokawa Micron Corporation, and the like. The classification mechanism will be schematically explained hereinbelow.

The pulverized product fed into a casing of a classifier descends along a classification zone on the outer circumference of the classifying rotor while being led by the spiral guide vane. The inner part of the classifying rotor and the classification zone are communicated via a classifying vane provided on the surface of the outer circumference of the classifying rotor. When the pulverized product is descended, fine powders carried along with a classifying air are aspirated to the inner part of the classifying rotor via the classifying vane, and discharged from a discharging outlet for fine powders. On the other hand, coarse powders that are not carried along with the classifying air are descended along the classification zone by gravitational force, and discharged from a discharging outlet for coarse powders.

Further, it is preferable that the classifier usable in the step (III) has two classifying rotors sharing the same driving shaft as a central shaft thereof in one casing, and that each of the classifying rotors independently rotates in the same direction. Specific examples of the classifiers provided with a classifying rotor on each of two top and bottom stages include a classifier shown in FIG. 1 of JP2001-293438 A, commercially available classifiers such as the “TTSP” Series commercially available from Hosokawa Micron Corporation, and the like.

When a classifying rotor is provided on each of two top and bottom stages, it is more preferable that an even higher precision classification can be achieved by adjusting an aspiration rate of classifying air, a rotational speed in each classifying rotor, or the like.

For example, the ratio of the rotational speed of the upper classifying rotor to the rotational speed of the lower classifying rotor (the rotational speed of the upper classifying rotor/the rotational speed of the lower classifying rotor) is preferably from 1/1.05 to 1.05/1, and more preferably 1/1, from the viewpoint of preventing turbulence.

In addition, it is preferable that the amount of air flow led from an upper air aspiration inlet to the amount of air flow led from a lower air aspiration inlet is nearly equal, from the viewpoint of classification precision and yield of toner.

It is preferable that the classifier usable in the step (III) is mainly used in the classification on the fine powder side (classification to cut off its lower limit) in order to remove fine powders. The fine powders removed during the classifying step may be subjected to the step (III) so as to recapture the necessary portion of the fine powders by re-classification.

The toner obtained by the step (III) has a standard deviation in the volume base particle size distribution of preferably 1/4 that of a volume-median particle size (D₅₀v) or less, more preferably from 1/10 to 1/4 that of D₅₀v, and even more preferably from 1/7 to 1/4 that of D₅₀v, from the viewpoint of uniformity of charge distribution.

The particles having particle sizes of (1.4×D₅₀v) μm or more are contained in an amount of preferably 7% by volume or less, more preferably 6% by volume or less, and even more preferably 5% by volume or less, in the toner, from the viewpoint of toner scattering around the dots. In addition, the particles having particle sizes of (0.6×number-median particle size (D₅₀p)) μm or less are contained in an amount of preferably 5% by number or less, and more preferably 4% by number or less, in the toner, from the viewpoint of preventing the lowering of fluidity and chargeability. In a case where a toner having a narrow particle size distribution is prepared, a high productivity according to the present invention is more remarkably exhibited.

In addition, the toner has a volume-median particle size (D₅₀v) of preferably from 3 to 7 μm, more preferably from 3.5 to 7 μm, even more preferably from 3.5 to 6.5 μm, and even more preferably from 4 to 6 μm, from the viewpoint of more remarkably exhibiting high productivity according to the present invention.

The toner obtainable by the present invention can be used without particular limitation in any of the development method alone as a toner for magnetic monocomponent development in the case where fine magnetic material powder is contained, or as a toner for nonmagnetic monocomponent development or as a toner for two-component development by mixing the toner with a carrier in the case where fine magnetic material powder is not contained.

### EXAMPLES

The following examples further describe and demonstrate embodiments of the present invention. The examples are given solely for the purposes of illustration and are not to be construed as limitations of the present invention.

[Softening Point]

The softening point refers to a temperature corresponding to h/2 of the height (h) of the S-shaped curve when plotting a downward movement of a plunger against temperature, when measured by using a flow tester (CAPILLARY RHEOMETER “CFT-500D,” commercially available from Shimadzu Corporation), in which a 1 g sample is extruded through a nozzle having a die pore size of 1 mm and a length of 1 mm, while heating the sample so as to raise the temperature at a rate of 6° C./min and applying a load of 1.96 MPa thereto with the plunger.

[Glass Transition Temperature]

The glass transition temperature refers to a temperature of an intersection of the extension of the baseline of equal to or lower than the temperature of the maximum endothermic peak and the tangential line showing the maximum inclination between the kick-off of the peak and the top of the peak, which is determined using a differential scanning calorimeter (“DSC 210,” commercially available from Seiko Instruments, Inc.), by raising its temperature to 200° C., cooling the sample from this temperature to 0° C. at a cooling rate of 10° C./min, and thereafter raising the temperature of the sample at a rate of 10° C./min.

[Acid Value]

The acid value is determined according to JIS K0070.

[Particle Size Distribution]

The particle size and particle size distribution of the toner is determined with a coulter counter “Coulter Multisizer II” (commercially available from Beckman Coulter) according to the following method.

(1) Preparation of Dispersion: 10 mg of a sample to be measured is added to 5 ml of a dispersion medium (a 5% by weight aqueous solution of “EMULGEN 109P” (commercially available from Kao Corporation, polyoxyethylene lauryl ether, HLB: 13.6)), and dispersed with an ultrasonic disperser for one minute. Thereafter, 25 ml of electrolytic solution (“Isotone II” (commercially available from Beckman Coulter)) is added thereto, and the mixture is further dispersed with the ultrasonic disperser for one minute, to give a dispersion.

(2) Measuring Apparatus: Coulter Multisizer II (commercially available from Beckman Coulter)

Aperture Diameter: 100 μm
Range of Particle Sizes to Be Determined: 2 to 60 μm
Analyzing Software: Coulter Multisizer AccuComp Ver. 1.19 (commercially available from Beckman Coulter)
   (3) Measurement Conditions: One-hundred milliliters of an electrolyte and a dispersion are added to a beaker, and the particle sizes of 30000 particles are determined under the conditions for concentration satisfying that the determination for 30000 particles are completed in 20 seconds.
   (4) The volume-median particle size (D₅₀v, μm), the number-median particle size (D₅₀p, μm), the standard deviation in the volume base particle size distribution, the content (% by volume) of the particles having particle sizes of (1.4×D₅₀v) μm or more, the content (% by number) of the particles having particle sizes of (0.6×D₅₀p) μm or less are obtained from the found values.

### Preparation Example of Resin

The amount 568 g of polyoxypropylene(2.2)-2,2-bis(4-hydroxyphenyl)propane, 792 g of polyoxyethylene(2.2)-2,2-bis(4-hydroxyphenyl)propane, 640 g of terephthalic acid, and 10 g of tin octylate were reacted at 210° C. under a nitrogen atmosphere while stirring. The degree of polymerization was monitored by the softening point, and the reaction was terminated when the softening point reached 110° C. The resulting resin is referred to as a resin A. The resin A had a glass transition temperature of 68° C., and an acid value of 5 mg KOH/g.

### Examples 1 to 4 and Comparative Examples 1 to 3

One hundred parts by weight of the resin A, 3.5 parts by weight of a colorant “ECB-301” (commercially available from DAINICHISEIKA COLOR & CHEMICALS MFG. CO., LTD.), 3.0 parts by weight of a carnauba wax “Carnauba Wax C1” (commercially available from Kato Yoko), 2.0 parts by weight of a paraffin wax “HNP-9” (commercially available from Nippon Seiro), and 0.5 parts by weight of a charge control agent “BONTRON P-51” (commercially available from Orient Chemical Co., Ltd.) were mixed with a Henschel mixer, and the resulting mixture was kneaded with a continuous twin open-roller type kneader “Kneadex” (commercially available from MITSUI MINING COMPANY, LIMITED), to give a melt-kneaded mixture.

Incidentally, the continuous twin open-roller type kneader used has a roller having an outer diameter of 0.14 m and an effective length of 0.8 m, and the operating conditions are a rotational speed of a higher rotation side roller (heat roller) of 75 r/min, a rotational speed of a lower rotation side roller (cooling roller) of 50 r/min, and a gap between the rollers of 0.1 mm. The temperatures of the heating medium and the cooling medium inside the rollers are as follows. The higher rotation side roller has a temperature at the raw material introducing side of 150° C., and a temperature at the melt-kneaded mixture discharging side of 130° C., and the lower rotation side roller has a temperature at the raw material introducing side of 35° C., and a temperature at the melt-kneaded mixture discharging side of 30° C. In addition, the feeding rate of the raw material mixture was 10 kg/hour.

Next, the resulting melt-kneaded mixture was cooled in the air, and thereafter the cooled mixture was roughly pulverized with Alpine Rotoplex (commercially available from Hosokawa Micron Corporation), to give a roughly pulverized product having a volume-median particle size (D₅₀v) of 500 μm.

The external additive shown in Table 1 was mixed with 100 parts by weight of the resulting roughly pulverized product in a Henschel mixer, and the resulting mixture was finely pulverized with a counter jet mill “400AFG” (commercially available from Hosokawa Micron Corporation), to give a finely pulverized product (upper limit cut-off classification powder).

Further, the pulverized product (upper limit cut-off classification powder) is classified by cutting off its lower limit (removal of fine powers) with a classifier “TTSP” (commercially available from Hosokawa Micron Corporation), to give a toner.

Table 1 shows particle size distribution and pulverization yield of the toners obtained by Examples and Comparative Examples. The pulverization yield is an yield of the toner to the roughly pulverized product.

TABLE 1

| | | | | | Particle Size Distribution of Toner | | | |
|---|---|---|---|---|---|---|---|---|
| | | | | | | Content of | | |
| | | | | | | particles having | Content of particles | |
| | | | | | | particle sizes of | having particle sizes | |
| | | Amount | Particle Size of Toner | | | (1.4 × D₅₀v) μm | of (0.6 × D₅₀p) μm | Pulverization |
| | External | (Parts by | D₅₀v | D₅₀p | Standard | or more | or less | Yield |
| | Additive* | weight) | (μm) | (μm) | Deviation | (% by volume) | (% by number) | (% by weight) |
| Ex. No. | | | | | | | | |
| 1 | HDK H20TA | 1.0 | 8.1 | 7.7 | 1.8 | 7.1 | 4.2 | 77 |
| 2 | HDK H20TA | 2.0 | 8.0 | 7.6 | 1.6 | 4.5 | 3.6 | 80 |
| 3 | HDK H05TA | 3.0 | 8.2 | 7.7 | 2.2 | 6.8 | 5.1 | 73 |
| 4 | HDK H20TA | 2.0 | 5.2 | 4.8 | 1.1 | 5.2 | 3.3 | 75 |
| Comp. | | | | | | | | |
| Ex. No. | | | | | | | | |
| 1 | HDK H20TA | 0.5 | 8.0 | 7.5 | 1.9 | 7.2 | 4.5 | 55 |
| 2 | HDK H20TM | 1.0 | 8.2 | 7.7 | 2.1 | 6.9 | 5.5 | 48 |
| 3 | HDK H20TA | 0.5 | 5.5 | 5.1 | 1.5 | 9.1 | 3.5 | 15 |

*HDK H20TA: Wacker Chemicals, positively chargeable silica, average particle size: 16 nm, treated with amino-modified silicone oil
HDK H05TA: Wacker Chemicals, positively chargeable silica, average particle size: 40 nm, treated with amino-modified silicone oil
HDK H20TM: Wacker Chemicals, negatively chargeable silica, average particle size: 16 nm, treated with hexamethyl disilazane

It can be seen from the above results that toners having a sharp particle size distribution are efficiently obtained in Examples, as compared to the toners obtained in Comparative Examples.

The toner obtained according to the present invention can be used for, for example, developing a latent image formed in electrophotography, electrostatic recording method, electrostatic printing method, or the like.

What is claimed is:

1. A process for preparing a toner comprising the steps of:
(I) melt-kneading a raw material mixture comprising a resin binder, a colorant, and a positively chargeable charge control agent;
(II) cooling the melt-kneaded mixture obtained in the step (I), and pulverizing the cooled mixture in the presence of a positively chargeable silica; and
(III) classifying the pulverized product obtained in the step (II), wherein the positively chargeable silica in the step (II) is present in an amount of from 0.8 to 6 parts by weight, based on 100 parts by weight of the melt-kneaded mixture obtained in the step (I).

2. The process according to claim 1, wherein the positively chargeable charge control agent is contained in the raw material mixture used in the step (I) in an amount of from 0.2 to 5% by weight.

3. The process according to claim 1, wherein the positively chargeable silica has an average particle size of from 4 to 40 nm.

4. The process according to claim 1, wherein the toner obtainable by the step (III) has a standard deviation in the volume base particle size distribution of 1/4 that of a volume-median particle size (D₅₀v) or less, and contains 7% by volume or less of particles having a particle size of (1.4×D₅₀v) μm or more, and 5% by number or less of particles having a particle size of (0.6×number-median particle size (D₅₀p)) μm or less.

5. The process according to claim 1, wherein the toner obtainable by the step (III) has a volume-median particle size (D₅₀v) of from 3 to 7 μm.

6. The process according to claim 1, wherein the positively chargeable silica is a silica treated with a hydrophobic treatment agent which gives positive chargeability.

7. The process according to claim 1, wherein the melt-kneading in the step (I) is carried out with an open-roller type kneader.

8. The process according to claim 1, wherein the pulverization in the step (II) is carried out with a fluidized bed type jet mill.

9. The process according to claim 1, wherein the classification in the step (III) is carried out with a classifier, the classifier comprising a classifying rotor comprising a driving shaft arranged in a casing as a central shaft thereof in a vertical direction, and a stationary spiral guiding vane arranged to share the same central shaft as the classifying rotor, wherein the stationary spiral guiding vane in the classification zone on an outer circumference of the classifying rotor with a given spacing to the outer circumference of the classifying rotor.

10. The process according to claim 1, wherein the positively chargeable charge control agent is a quaternary ammonium salt compound.

11. The process according to claim 1, wherein the resin binder comprises a polyester having a softening point of from 80° to 165° C.

12. A toner obtainable by a process comprising the steps of:
(I) melt-kneading a raw material mixture comprising a resin binder, a colorant, and a positively chargeable charge control agent;
(II) cooling the melt-kneaded mixture obtained in the step (I), and pulverizing the cooled mixture in the presence of a positively chargeable silica; and
(III) classifying the pulverized product obtained in the step (II), wherein the positively chargeable silica in the step (II) is present in an amount of from 0.8 to 6 parts by weight, based on 100 parts by weight of the melt-kneaded mixture obtained in the step (I).
